(19) United States
(12) Patent Application Publication
(10) Pub. No.: US 2024/0209189 A1
(43) Pub. Date: Jun. 27, 2024

(54) RUBBER COMPOSITION FOR TIRE TREAD AND PNEUMATIC TIRE USING THE SAME

(71) Applicant: Toyo Tire Corporation, Itami-shi (JP)

(72) Inventors: Yousuke Nishio, Itami-shi (JP); Yugo Sumino, Itami-shi (JP)

(73) Assignee: Toyo Tire Corporation, Itami-shi (JP)

(21) Appl. No.: 18/530,773

(22) Filed: Dec. 6, 2023

(30) Foreign Application Priority Data
Dec. 23, 2022 (JP) 2022-206505

(51) Int. Cl. C08L 9/00; B60C 1/00; C08K 7/22

(52) U.S. Cl. CPC C08L 9/00; B60C 1/0016; C08K 7/22; C08K 2201/016; C08L 2205/03

(57) ABSTRACT

Provided is a rubber composition for a tire tread, including, per 100 parts by mass of a solid diene rubber, 0.5 to 10 parts by mass of porous cellulose particles having a porosity of 75 to 95%, 3 to 20 parts by mass of a terpene-based resin, and 2 to 30 parts by mass of a liquid rubber.

### BACKGROUND OF THE INVENTION

### 1. Field of the Invention

The present invention relates to a rubber composition for a tire tread and also to a pneumatic tire using the same.

### 2. Description of Related Art

For rubber compositions used in tires, there is a need to improve grip performance on wet road surfaces (wet grip performance) and grip performance on frozen road surfaces (on-ice braking performance).

In order to address such a problem, JP2019-151743A describes that on-ice performance can be improved by using a modified natural rubber and a terpene-based resin together. However, there still has been room for improvement regarding wet grip performance.

In addition, JP2021-91839A describes that the incorporation of a liquid rubber and porous cellulose particles leads to excellent wet grip performance and on-ice braking performance. However, the performance required by the market is increasing year by year, and further improvements are needed.

### SUMMARY OF THE INVENTION

In view of the above points, an object of an aspect of the invention is to provide a rubber composition for a tire tread, which has excellent wet grip performance and on-ice braking performance.

The invention includes the following embodiments.
[1] A rubber composition for a tire tread, including, per 100 parts by mass of a solid diene rubber, 0.5 to 10 parts by mass of porous cellulose particles having a porosity of 75 to 95%, 3 to 20 parts by mass of a terpene-based resin, and 2 to 30 parts by mass of a liquid rubber.
[2] The rubber composition for a tire tread according to [1], in which the solid diene rubber includes an isoprene-based rubber and a butadiene rubber in a mass ratio (isoprene-based rubber/butadiene rubber) of 30/70 to 70/30.
[3] The rubber composition for a tire tread according to [1] or [2], in which the total content of an oil, the liquid rubber, and the terpene-based resin is 22 to 45 parts by mass per 100 parts by mass of the solid diene rubber.
[4] A pneumatic tire made using the rubber composition according to any one of [1] to [3] for a tread.

According to a rubber composition for a tire tread of an aspect of the invention, a pneumatic tire having excellent wet grip performance and on-ice braking performance is obtained.

### DESCRIPTION OF EMBODIMENTS

Hereinafter, matters relevant to the practice of the invention will be described in detail.

A rubber composition for a tire tread according to this embodiment includes, per 100 parts by mass of a solid diene rubber. 0.5 to 10 parts by mass of porous cellulose particles having a porosity of 75 to 95%. 3 to 20 parts by mass of a terpene-based resin, and 2 to 30 parts by mass of a liquid rubber

As used herein, “solid” refers to having no fluidity at 23° C., and “liquid” refers to having fluidity at 23° C.

As the solid diene rubber, isoprene-based rubbers such as natural rubber (NR) and isoprene rubber (IR), butadiene rubber (BR), styrene butadiene rubber (SBR), nitrile rubber (NBR), chloroprene rubber (CR), butyl rubber (IIR), styrene-isoprene copolymer rubber, butadiene-isoprene copolymer rubber, styrene-isoprene-butadiene copolymer rubber, and the like can be mentioned. Among them, isoprene-based rubbers and butadiene rubber (BR) are preferable.

In a preferred embodiment, the solid diene rubber preferably includes an isoprene-based rubber and a butadiene rubber in a mass ratio (isoprene-based rubber/butadiene rubber) of 30/70 to 70/30, more preferably 40/60 to 60/40.

The rubber composition for a tire tread according to this embodiment incorporates porous cellulose particles having a porosity of 75 to 95%. Porous cellulose particles are a natural material that is biodegradable, and have a porous structure and high chemical stability. For such characteristics, they are used in deodorants, garbage disposal substrates, cigarette filter substrates, and the like.

The porosity of the porous cellulose particles is not particularly limited as long as it is 75 to 95%, but is more preferably 85 to 95%. When the porosity is 75% or more, the on-ice braking performance improving effect is easier to obtain, while when it is 95% or less, the strength of particles is maintained, and such particles are less likely to deform or fracture during mixing with a rubber component.

The porosity of porous cellulose particles can be determined as follows. That is, the volume of a constant mass of sample (i.e., porous cellulose particles) is measured with a measuring cylinder, then the bulk specific gravity is determined, and the porosity is determined using the following formula.

$$Porosity [ \% ] = ( void volume [ ml ] ) / ( bulk volume of sample [ ml ] ) \times 100$$

$$= \{ ( bulk volume of sample [ ml ] ) - ( actual volume of sample [ ml ] ) \} / ( bulk volume of sample [ ml ] ) \times 100$$

$$\{ 1 - ( actual volume of sample [ ml ] ) / ( bulk volume of sample [ ml ] ) \} \times 100$$

$$\{ 1 - ( bulk specific gravity of sample [ g / ml ] ) / ( true specific gravity of sample [ g / ml ] ) \} \times 100$$

Here, the true specific gravity of cellulose is 1.5.

The porous cellulose particle content is, per 100 parts by mass of the solid diene rubber, 0.5 to 10 parts by mass, preferably 0.5 to 8 parts by mass, and more preferably 1 to 5 parts by mass. When the porous cellulose particle content is within the above range, the wet grip performance and on-ice braking performance improving effects are easier to obtain.

The average particle size of the porous cellulose particles is not particularly limited, but is preferably 1,000 μm or less, more preferably 100 to 800 μm, and still more preferably 200 to 800 μm. In the case where the average particle size is 1,000 μm or less as described above, excellent abrasion resistance performance is easier to obtain.

The porous cellulose particles are preferably spherical particles having a major axis/minor axis ratio of 1 to 2, and more preferably spherical particles having a major axis/minor axis ratio of 1 to 1.5. As a result of using particles with such a spherical structure, the dispersibility into the rubber composition improves, and excellent on-ice braking performance and abrasion resistance performance are easier to obtain.

The average particle size and major axis/minor axis ratio of porous cellulose particles are determined as follows. That is, porous cellulose particles are observed under a microscope to obtain an image. Using this image, the major and minor axes of 100 particles are measured (in the case where the major axis and the minor axis are the same, the length in a certain axial direction and the length in the axial direction perpendicular thereto are measured), and their average is calculated to obtain the average particle size. In addition, from the average of the major axes divided by minor axes, the major axis/minor axis ratio is obtained.

Such porous cellulose particles are commercially available as “Viscopearl®” from Rengo Co., Ltd., for example, and are also described in JP2001-323095A and JP2004-115284A (the contents of which are incorporated herein by reference in their entirety), and they can be favorably used.

Specifically, it is preferable to use cellulose particles obtained by adding a pore-forming agent to an alkaline cellulose solution, such as viscose, and allowing the coagulation and regeneration of cellulose to proceed simultaneously with foaming with the pore-forming agent. As pore-forming agents, carbonates such as calcium carbonate can be mentioned. When a carbonate is uniformly mixed with and dispersed in an alkaline cellulose solution, and droplets of the obtained dispersion are brought into contact with an acidic solution such as a hydrochloric acid, the acid allows the coagulation and regeneration of cellulose to proceed simultaneously with the foaming and decomposition of the carbonate, and porous cellulose particles having a high porosity as described above are obtained.

The terpene-based resin content is, per 100 parts by mass of the solid diene rubber, 3 to 20 parts by mass, preferably 5 to 15 parts by mass. When the terpene-based resin content is within the above range, excellent on-ice braking performance is easier to obtain.

A terpene-based resin is a resin whose raw material is at least one member selected from terpene compounds. As terpene compounds, for example, α-pinene, β-pinene, 3-carene (δ-3-carene), dipentene, limonene, myrcene, alloocimene, ocimene, α-phellandrene, α-terpinene, γ-terpinene, terpinolene, 1,8-cineole, 1,4-cineole, α-terpineol, β-terpineol, γ-terpineol, and the like can be mentioned. Terpene-based resins composed of these terpene compounds may be modified (e.g., phenol modification, aromatic modification, hydrocarbon modification, etc.) into modified terpene-based resins (e.g., terpene phenol-based resins, styrene-modified terpene-based resins, aromatic modified terpene-based resins, etc.).

The liquid rubber content is, per 100 parts by mass of the solid diene rubber, 2 to 30 parts by mass, more preferably 5 to 30 parts by mass.

As liquid rubbers, for example, diene rubbers such as isoprene rubber, butadiene rubber, styrene butadiene rubber, isoprene butadiene rubber, isoprene styrene rubber, isoprene butadiene styrene rubber, isobutylene, and ethylene propylene diene rubber (EPDM) can be mentioned. Among them, isoprene rubber, butadiene rubber, and styrene butadiene rubber are preferable. These liquid rubbers may be modified by carboxylation or methacrylation. In addition, one that is a copolymer may be an alternating copolymer, a block copolymer, or a random copolymer. One of these liquid rubbers may be used alone, and it is also possible to use a blend of two or more kinds.

As liquid rubbers, commercially available products can also be utilized. For example, as isoprene-based rubbers, LIR-30, LIR-50, LIR-310, LIR-390, LIR-410, UC-203, UC-102, LIR-290, and LIR-700 manufactured by Kuraray Co., Ltd., etc., can be mentioned. As butadiene-based rubbers. LBR-307, LBR-305, and LBR-352 manufactured by Kuraray Co., Ltd., etc., can be mentioned. As styrene butadiene-based rubbers, L-SBR-820 and L-SBR-841 manufactured by Kuraray Co., Ltd., etc., can be mentioned.

The number average molecular weight of the liquid rubber is not particularly limited, but is preferably 3.000 to 150,000, and more preferably 5,000 to 100,000. As used herein, the number average molecular weight of a liquid rubber is measured by gel permeation chromatography (GPC), and is a polystyrene-equivalent value calculated using a commercially available standard polystyrene at a measurement temperature of 40° C., a flow rate of 1.0 mL/min, a concentration of 1.0 g/L, and an injection volume of 100 μL using a differential refractive index detector (RI) as the detector. “TSKGel SuperHZM-M” manufactured by Tosoh Corporation as the column, and THE as the solvent.

In the rubber composition for a tire tread of the invention, a solid diene rubber is used together with predetermined amounts of porous cellulose particles, liquid rubber, and terpene-based resin, and, as a result, excellent wet grip performance and on-ice braking performance are obtained. This mechanism is not clear, but is presumably as follows. First, as a result of incorporating porous cellulose particles, pores of the porous cellulose particles effectively absorb and remove water from the water film on icy road surfaces, and, further, spalled particles and pore wall edges exhibit a scratching effect on icy road surfaces. Then, as a result of using a liquid rubber and a terpene-based resin together, the solid diene rubber softens, and the shear stress of the rubber composition decreases. This suppresses the collapse of porous cellulose particles, presumably leading to improved on-ice braking performance. In addition, as a result of using a terpene resin, while maintaining softness in a low temperature region, hysteresis loss on wet road surfaces is also ameliorated, presumably leading to improved wet grip performance and improved on-ice braking performance.

The rubber composition for a tire tread according to this embodiment may contain a reinforcing filler. Examples of reinforcing fillers include silica and/or carbon black. Silica is not particularly limited, and, for example, wet silica such as wet-precipitated silica or wet-gelled silica may be used. The silica content is not particularly limited, but is, per 100 parts by mass of the solid diene rubber, preferably 20 to 80 parts by mass, and more preferably 30 to 70 parts by mass. When the silica content is within the above range, excellent on-ice braking performance is easier to obtain.

Carbon black is not particularly limited, and known various species can be used. The carbon black content is not particularly limited, but is, per 100 parts by mass of the solid diene rubber, preferably 1 to 30 parts by mass, and more preferably 1 to 20 parts by mass.

The reinforcing filler content (total amount of silica and carbon black) is not particularly limited, but is, per 100 parts by mass of the solid diene rubber, preferably 40 to 100 parts by mass, more preferably 50 to 90 parts by mass, and still more preferably 50 to 80 parts by mass.

The rubber composition according to this embodiment preferably contains a silane coupling agent. In that case, the silane coupling agent content is, per 100 parts by mass of silica, preferably 1 to 20 parts by mass, and more preferably 1 to 15 parts by mass.

In addition to the above components, the rubber composition according to this embodiment can incorporate various additives generally used in rubber compositions, such as zinc oxide, stearic acid, antioxidants, waxes, oils, vulcanizing agents, and vulcanization accelerators.

The oil content is not particularly limited, but is, per 100 parts by mass of the solid diene rubber, preferably 0 to 30 parts by mass, and more preferably 0 to 25 parts by mass. The total oil, liquid rubber, and terpene-based resin content is, per 100 parts by mass of the solid diene rubber, preferably 22 to 45 parts by mass, more preferably 25 to 40 parts by mass, and still more preferably 30 to 40 parts by mass.

As the vulcanizing agents, sulfur is preferably used. The vulcanizing agent content is not particularly limited, but is, per 100 parts by mass of the solid diene rubber, preferably 0.1 to 10 parts by mass, and more preferably 0.5 to 5 parts by mass. In addition, as the vulcanization accelerators, for example, sulfenamide-based, thiuram-based, thiazole-based, guanidine-based, and like various vulcanization accelerators can be mentioned. One of them can be used alone, and it is also possible to use a combination of two or more kinds. The vulcanization accelerator content is not particularly limited, but is, per 100 parts by mass of the solid diene rubber, preferably 0.1 to 7 parts by mass, and more preferably 0.5 to 5 parts by mass.

The rubber composition according to this embodiment can be made by kneading in the usual manner using a commonly used mixing machine, such as a Banbury mixer, a kneader, or a roll. That is, for example, in the first mixing stage, additives excluding a vulcanizing agent and a vulcanization accelerator are added to a solid diene rubber and mixed, and then, in the final mixing stage, a vulcanizing agent and a vulcanization accelerator are added to the obtained mixture and mixed, whereby a rubber composition can be prepared.

The rubber composition thus obtained is applicable to the treads of pneumatic tires of various sizes for various uses, including tires for passenger cars, large-sized tires for trucks and buses, and the like. That is, the rubber composition is formed into a predetermined shape in the usual manner, for example, by extrusion, and combined with other parts to make a green tire. Subsequently, the green tire is vulcanization-molded at 140 to 180° C., for example, whereby a pneumatic tire can be produced.

### EXAMPLES

Hereinafter, examples of the invention will be shown, but the invention is not limited to these examples.

Using a lab mixer, according to the formulation (parts by mass) shown in Table 1 below, first, in the first mixing stage, ingredients excluding sulfur and vulcanization accelerators were added to a solid diene rubber and kneaded (discharge temperature=160° C.). Next, in the final mixing stage, sulfur and vulcanization accelerators were added to the obtained kneaded product and kneaded (discharge temperature=)90° C., thereby preparing a rubber composition. The details of the components in Table 1 are as follows.
NR: RSS #3
BR: “BR150B” manufactured by Ube Industries, Ltd.
Porous cellulose particles: “Viscopearl Mini” manufactured by Rengo Co., Ltd. (average particle size=400 μm, major axis/minor axis ratio of particles=1.11, porosity=87%)
Silica: “Nipsil AQ” manufactured by Tosoh Silica Corporation
Silane coupling agent: “Si-75” manufactured by Evonik
Carbon black: “SEAST 7HM” manufactured by Tokai Carbon Co., Ltd.
Zinc oxide: “Zinc Oxide, Type 2” manufactured by Mitsui Mining & Smelting Co., Ltd.
Stearic acid: “LUNAC S-20” manufactured by Kao Corporation
Wax: “OZOACE 0355” manufactured by Nippon Seiro Co., Ltd.
Antioxidant: “NOCRAC 6C” manufactured by Ouchi Shinko Chemical Industrial Co., Ltd.
C5/C9-based resin: “Petrotack 90” manufactured by Tosoh Corporation, softening point=100° C.
Terpene-based resin: “SYLVATRAXX 4150” manufactured by Kraton Corporation, softening point=115° C.
Oil: “Process P200” manufactured by ENEOS Corporation
Liquid rubber 1: “LIR-50” manufactured by Kuraray Co., Ltd., liquid isoprene rubber, number average molecular weight (Mn)=54,000
Liquid rubber 2: “L-SBR-841” manufactured by Kuraray Co., Ltd., liquid styrene butadiene rubber, number average molecular weight (Mn)=10,000
Liquid rubber 3: “LBR-307” manufactured by Kuraray Co., Ltd., liquid butadiene rubber, number average molecular weight (Mn)=8,000
Vulcanization accelerator 1: “SOXINOL CZ” manufactured by Sumitomo Chemical Co., Ltd.
Vulcanization accelerator 2: “NOCCELER DZ-G” manufactured by Ouchi Shinko Chemical Industrial Co., Ltd.
Sulfur: “Powder Sulfur” manufactured by Tsurumi Chemical Industry Co., Ltd.

Each obtained rubber composition was measured for the collapse rate of porous cellulose particles and abrasion resistance performance. In addition, a tire applying each rubber composition to the tread was made and evaluated for on-ice braking performance and wet grip performance. The measurement and evaluation methods are as follows.
Collapse Rate of Porous Cellulose Particles: A test piece vulcanized at 160° C.×20 minutes was cut at any point, and its cross section was measured at a magnification of 30 using a scanning electron microscope (SEM). From the holes appearing in the obtained image, any 50 holes were selected, and the major and minor axes of each hole were measured. The cross-sectional area of each hole was calculated from the opening of the hole as an ellipse, and the average was determined. Then, taking the collapse rate in Comparative Example 1 as 100%, the ratio of the hole cross-sectional area in Comparative Example 1 to the hole cross-sectional area in each example ((Comparative Example 1/Example)×100) was defined as the collapse rate and shown in Table 1. A higher collapse rate indicates more collapse of cellulose particles.
On-Ice Braking Performance: The above studless tire was installed on a 2,000-cc 4WD vehicle. At a temperature of −2° C. to −6° C., ABS was activated from a speed of 40 km/h, and the braking distance on ice was measured (average of n=10). The reciprocal of the measured braking distance was expressed as an index taking Comparative Example 1 as 100. The larger the index, the shorter the braking distance, indicating better on-ice braking performance.
Wet Grip Performance: The above studless tire was installed on a 2,000-cc FR vehicle. At a temperature of 23° C. to 26° C., ABS was activated from a speed of 80 km/h on a road surface flooded with water to about 1 mm, and the braking distance was measured (average of n=10). The reciprocal of the measured braking distance was expressed as an index taking Comparative Example 1 as 100. The larger the index, the shorter the braking distance, indicating better wet grip performance.
Abrasion Resistance Performance: In accordance with JIS K6264, using a Lambour abrasion tester manufactured by Iwamoto Seisakusho Co., Ltd., the abrasion loss was measured under the conditions of a load of 40 N and a slip ratio of 30%. The reciprocal of the measured abrasion loss was expressed as an index taking the value of Comparative Example 1 as 100. A larger index indicates better abrasion resistance performance.

TABLE 1

| | Comp. Ex. 1 | Comp. Ex. 2 | Comp. Ex. 3 | Comp. Ex. 4 | Ex. 1 | Ex. 2 | Ex. 3 | Ex. 4 | Ex. 5 | Ex. 6 |
|---|---|---|---|---|---|---|---|---|---|---|
| NR | 50 | 50 | 50 | 50 | 50 | 50 | 50 | 50 | 50 | 50 |
| BR | 50 | 50 | 50 | 50 | 50 | 50 | 50 | 50 | 50 | 50 |
| Porous cellulose particles | 2 | — | — | 2 | 2 | 2 | 2 | 2 | 2 | 2 |
| Silica | 50 | 50 | 50 | 50 | 50 | 50 | 50 | 50 | 50 | 50 |
| Silane coupling agent | 3.5 | 3.5 | 3.5 | 3.5 | 3.5 | 3.5 | 3.5 | 3.5 | 3.5 | 3.5 |
| Carbon black | 9 | 9 | 9 | 9 | 9 | 9 | 9 | 9 | 9 | 9 |
| Zinc oxide | 2 | 2 | 2 | 2 | 2 | 2 | 2 | 2 | 2 | 2 |
| Stearic acid | 2 | 2 | 2 | 2 | 2 | 2 | 2 | 2 | 2 | 2 |
| Wax | 1.5 | 1.5 | 1.5 | 1.5 | 1.5 | 1.5 | 1.5 | 1.5 | 1.5 | 1.5 |
| Antioxidant | 4 | 4 | 4 | 4 | 4 | 4 | 4 | 4 | 4 | 4 |
| C5/C9-based resin | 7 | 7 | — | — | — | — | — | — | — | — |
| Terpene-based resin | — | — | 7 | — | 7 | 7 | 7 | 7 | 7 | 7 |
| Oil | 20 | 20 | 20 | 20 | 20 | 20 | 10 | 10 | — | — |
| Liquid rubber 1 | 8.5 | 8.5 | 8.5 | — | 8.5 | — | 8.5 | — | 28.5 | — |
| Liquid rubber 2 | — | — | — | — | — | 8.5 | — | 8.5 | — | 28.5 |
| Liquid rubber 3 | — | — | — | — | — | — | 10 | 10 | — | — |
| Vulcanization accelerator 1 | 0.9 | 0.9 | 0.9 | 0.9 | 0.9 | 0.9 | 0.9 | 0.9 | 0.9 | 0.9 |
| Vulcanization accelerator 2 | 1.1 | 1.1 | 1.1 | 1.1 | 1.1 | 1.1 | 1.1 | 1.1 | 1.1 | 1.1 |
| Sulfur | 1.4 | 1.4 | 1.4 | 1.4 | 1.4 | 1.4 | 1.4 | 1.4 | 1.4 | 1.4 |
| Oil + liquid rubber + resin | 35.5 | 35.5 | 35.5 | 20 | 35.5 | 35.5 | 35.5 | 35.5 | 35.5 | 35.5 |
| Collapse rate of porous cellulose particles (%) | 100 | — | — | 150 | 87 | 88 | 85 | 83 | 90 | 90 |
| On-ice braking performance | 100 | 91 | 100 | 76 | 112 | 118 | 116 | 122 | 110 | 120 |
| Wet grip performance | 100 | 95 | 102 | 82 | 108 | 111 | 106 | 109 | 110 | 106 |
| Wear resistance performance | 100 | 105 | 107 | 123 | 110 | 108 | 125 | 109 | 111 | 132 |

The results are as shown in Table 1. Examples 1 to 6 were superior to Comparative Example 1 in on-ice braking performance, wet grip performance, and abrasion resistance performance.

Comparative Example 2 is an example of not incorporating porous cellulose particles. Comparative Example 2 was inferior to Comparative Example 1 in on-ice braking performance and wet grip performance.

Comparative Example 3 is an example of not incorporating porous cellulose particles and incorporating a terpene-based resin. Comparative Example 3 was inferior to Examples 1 to 6 in on-ice braking performance, wet grip performance, and abrasion resistance performance.

Comparative Example 4 is an example of incorporating porous cellulose particles and not incorporating a resin and a liquid rubber. In Comparative Example 4, compared to Comparative Example 1, the collapse rate of porous cellulose particles was higher, and the on-ice braking performance and wet grip performance were inferior.

The rubber composition of the invention can be used as a rubber composition for various tires for passenger cars, light trucks, buses, and the like.

What is claimed is:

1. A rubber composition for a tire tread, comprising,
per 100 parts by mass of a solid diene rubber:
0.5 to 10 parts by mass of porous cellulose particles having a porosity of 75 to 95%;
3 to 20 parts by mass of a terpene-based resin; and
2 to 30 parts by mass of a liquid rubber.

2. The rubber composition for a tire tread according to claim 1, wherein the solid diene rubber includes an isoprene-based rubber and a butadiene rubber in a mass ratio (isoprene-based rubber/butadiene rubber) of 30/70 to 70/30.

3. The rubber composition for a tire tread according to claim 1, wherein the total content of an oil, the liquid rubber, and the terpene-based resin is 22 to 45 parts by mass per 100 parts by mass of the solid diene rubber.

4. The rubber composition for a tire tread according to claim 3, wherein the oil content is 0 to 30 parts by mass per 100 parts by mass of the solid diene rubber.

5. The rubber composition for a tire tread according to claim 1, wherein the porous cellulose particles are spherical particles having a major axis/minor axis ratio of 1 to 2.

6. The rubber composition for a tire tread according to claim 1, wherein the liquid rubber is at least one member selected from the group consisting of a liquid isoprene rubber, a liquid butadiene rubber, and a liquid styrene butadiene rubber.

7. The rubber composition for a tire tread according to claim 1, further comprising an oil, zinc oxide, stearic acid, a wax, an antioxidant, a vulcanization accelerator, sulfur, and 40 to 100 parts by mass of a reinforcing filler per 100 parts by mass of the solid diene rubber, wherein
the oil, the liquid rubber, and the terpene-based resin are present at a total content of 22 to 45 parts by mass per 100 parts by mass of the solid diene rubber.

8. A pneumatic tire made using the rubber composition according to claim 1 for a tread.
